(19) United States
(12) Patent Application Publication
(10) Pub. No.: US 2012/0123578 A1
(43) Pub. Date: May 17, 2012

(54) MARKET OPTIMIZATION OF LIQUEFIED NATURAL GAS PROCESS

(75) Inventors: Weldon L. Ransbarger, Cypress, TX (US); Jon M. Mock, Katy, TX (US); Jaleel Valappil, Houston, TX (US); Sanjay Wale, Katy, TX (US); Sriram Ramani, Katy, TX (US); Satish Gandhi, Sugar Land, TX (US)

(73) Assignee: CONOCOPHILLIPS COMPANY, Houston, TX (US)

(21) Appl. No.: 12/946,361

(22) Filed: Nov. 15, 2010

(51) Int. Cl. G06F 19/00; F25J 1/02

(52) U.S. Cl. 700/104; 62/611

(57) ABSTRACT

A method includes controlling a process control system for coordinating the operation of a liquefied natural gas (LNG) process.

### FIELD OF THE INVENTION

The present invention generally relates to process control systems. In another aspect, the present invention generally relates to a system and method for coordination of liquefied natural gas (LNG) processes.

### BACKGROUND OF THE INVENTION

Cryogenic liquefaction is commonly used to convert natural gas into a more convenient form for transportation and/or storage. Because liquefying natural gas greatly reduces its specific volume, large quantities of natural gas can be economically transported and/or stored in liquefied form.

Transporting natural gas in its liquefied form can effectively link a natural gas source with a distant market when the source and the market are not connected by a pipeline. This situation commonly arises when the source of natural gas and the market for the natural gas are separated by large bodies of water. In such cases, liquefied natural gas (LNG) can be transported from the source to the market using specially designed ocean-going LNG tankers.

Storing natural gas in its liquefied form can help balance periodic fluctuations in natural gas supply and demand. In particular, LNG can be “stockpiled” for use when natural gas demand is low and/or supply is high. As a result, future demand peaks can be met with LNG from storage, which can be vaporized as demand requires.

Numerous systems exist in the prior art for the liquefaction of natural gas in which the gas is liquefied by sequentially passing the gas at an elevated pressure through a plurality of cooling stages whereupon the gas is cooled to successively lower temperatures until the liquefaction temperature is reached. Cooling is generally accomplished by indirect heat exchange with one or more refrigerants such as propane, propylene, ethane, ethylene, methane, nitrogen, carbon dioxide, or combinations of the preceding refrigerants (e.g., mixed refrigerant systems).

Today, the LNG market is progressing towards an open market system with shorter and shorter term supply contracts in contrast to the long term supply commitments that began the industry. In fact, many localized open markets have emerged and are flourishing today. This transition is opening the door for optimization of LNG product slates to be conducted on a shipment by shipment basis. Varying the removal rate of heavier components can control the volume and heating value of the LNG produced, as well as the composition of the facilities natural gas liquid (NGL) product. However, while operations personnel have the ability to modify facilities operation to achieve different products based on the prevailing commercial conditions, the operators ability to maintain operations near the optimum over a 24 hour period with fluctuating ambient temperatures and other activities taking place in the facility may not be sufficient to capture full economic value of an optimized product slate.

Therefore, a need exits for running a liquefaction plant at optimal conditions while handling various operational constraints and disturbances.

### SUMMARY OF THE INVENTION

In one embodiment of the present invention, a method includes (a) controlling a liquefied natural gas (LNG) production process for producing liquefied natural gas using an advanced process control system, wherein the advanced process control system employs a model predictive controller, wherein the model predictive controller includes variables such as controlled, manipulated and disturbance, wherein the model predictive controller includes a control route for determining moves of the manipulated variables based on controlled variable(s) and one or more of the disturbance variables; and (b) controlling the advanced process control system so as to optimize at least one process objective using the advanced process control system.

In another embodiment of the present invention, a method includes (a) controlling a liquefied natural gas (LNG) production process for producing liquefied natural gas using an advanced process control system; and (b) controlling the advanced process control system so as to optimize at least one process objective using the advanced process control system.

In another embodiment of the present invention, a computer program embodied on a computer readable medium, the computer program comprising computer readable code for (a) controlling a process control system that controls a process comprising a liquefied natural gas production process; and (b) optimizing at least one process objective using the first process control system.

### BRIEF DESCRIPTION OF THE DRAWINGS

The invention, together with further advantages thereof, may best be understood by reference to the following description taken in conjunction with the accompanying drawings in which:

FIG. 1 is a flow diagram that illustrates a general advanced process control system in accordance with the present invention.

FIG. 2 is a flow diagram that illustrates the application of a process control system to a liquefied natural gas (LNG) production processing operation according to one embodiment of the present invention.

### DETAILED DESCRIPTION OF THE INVENTION

Reference will now be made in detail to embodiments of the present invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the appended claims and their equivalents.

A cascaded refrigeration process uses one or more refrigerants for transferring heat energy from the natural gas stream to the refrigerant and ultimately transferring said heat energy to the environment. In essence, the overall refrigeration system functions as a heat pump by removing heat energy from the natural gas stream as the stream is progressively cooled to lower, and lower temperatures. The design of a cascaded refrigeration process involves a balancing of thermodynamic efficiencies and capital costs. In heat transfer processes, thermodynamic irreversibility is reduced as the temperature gradients between heating and cooling fluids become smaller, but obtaining such small temperature gradients generally requires significant increases in the amount of heat transfer area, major modifications to various process equipment, and the proper selection of flow rates through such equipment so as to ensure that both flow rates and approach and outlet temperatures are compatible with the required heating/cooling duty.

As used herein, the term “open-cycle cascaded refrigeration process” refers to a cascaded refrigeration process comprising at least one closed refrigeration cycle and one open refrigeration cycle where the boiling point of the refrigerant/cooling agent employed in the open cycle is less than the boiling point of the refrigerating agent or agents employed in the closed cycle(s) and a portion of the cooling duty to condense the compressed open-cycle refrigerant/cooling agent is provided by one or more of the closed cycles. In the current invention, a predominantly methane stream is employed as the refrigerant/cooling agent in the open cycle. This predominantly methane stream originates from the processed natural gas feed stream and can include the compressed open methane cycle gas streams. As used herein, the terms “predominantly”, “primarily”, “principally”, and “in major portion”, when used to describe the presence of a particular component of a fluid stream, shall mean that the fluid stream comprises at least 50 mole percent of the stated component. For example, a “predominantly” methane stream, a “primarily” methane stream, a stream “principally” comprised of methane, or a stream comprised “in major portion” of methane each denote a stream comprising at least 50 mole percent methane.

One of the most efficient and effective means of liquefying natural gas is via an optimized cascade-type operation in combination with expansion-type cooling. Such a liquefaction process involves the cascade-type cooling of a natural gas stream at an elevated pressure, (e.g., about 650 psia) by sequentially cooling the gas stream via passage through a multistage propane or propylene cycle, a multistage ethane or ethylene cycle, and an open-end methane cycle which utilizes a portion of the feed gas as a source of methane and which includes therein a multistage expansion cycle to further cool the same and reduce the pressure to near-atmospheric pressure. In the sequence of cooling cycles, the refrigerant having the highest boiling point is utilized first followed by a refrigerant having an intermediate boiling point and finally by a refrigerant having the lowest boiling point. As used herein, the terms “upstream” and “downstream” shall be used to describe the relative positions of various components of a natural gas liquefaction plant along the flow path of natural gas through the plant.

The present invention utilizes a process control system to maximize the value extracted from a liquefied natural gas (LNG) production facility in order to produce liquefied natural gas on a shipment by shipment basis. The operating conditions of the LNG production facility can be varied to optimize the facility on the basis of operating costs, liquid petroleum gas (LPG) commodity price, liquefied natural gas (LNG) commodity price, LNG/LPG production rates, domestic gas sales, and facility fuel efficiency. The process control system is capable of maintaining the LNG production facility at or near the economic optimum over a wide range of varying conditions, including feed pressure, feed temperature, feed composition, varying ambient conditions (such as temperature and relative humidity), varying wind direction, and turbine performance at the end of “overhaul life,” as well as, when the operator must attend to other ongoing issues in the facility.

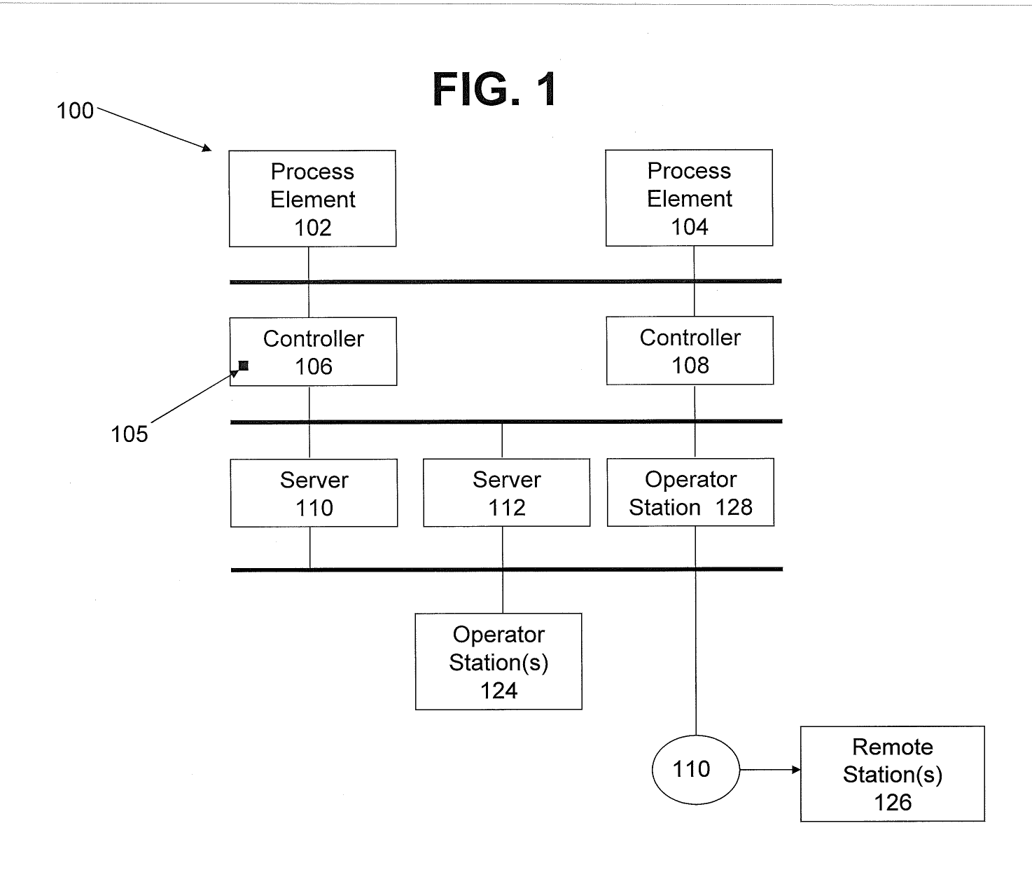

FIG. 1 provides an example of a process control system 100 which could be utilized to operate the present invention. The embodiment of the process control system 100 shown in FIG. 1 is for illustrative purposes only. Other embodiments of the process control system 100 may be used without departing from the scope of this disclosure.

In this example, the process control system 100 includes one or more process elements 102 and 104. The process elements 102 and 104 represent components in a process or production system that may perform any of a wide variety of functions. Each of the process elements 102 and 104 includes any hardware, software, firmware, or combination thereof for performing one or more functions in a process or production system. While only two process elements 102 and 104 are shown in this example, any number of process elements may be included in a particular implementation of the process control system 100.

Two controllers 106 and 108 are coupled to the process elements 102 and 104. The controllers 106 and 108 control the operation of the process elements 102 and 104. For example, the controllers 106 and 108 could be capable of monitoring the operation of the process elements 102 and 104 and providing control signals to the process elements 102 and 104. Each of the controllers 106 and 108 includes any hardware, software, firmware, or combination thereof for controlling one or more of the process elements 102 and 104. The controllers 106 and 108 could, for example, include aspenONE® Advanced Process Control technology such as DMCplus® controller. The controllers 106 and 108 could, for example, include processors 105 of the X86 processor family running MICROSOFT WINDOWS operating system.

Two servers 110 and 112 are coupled to the controllers 106 and 108. The servers 110 and 112 perform various functions to support the operation and control of the controllers 106 and 108 and the process elements 102 and 104. For example, the servers 110 and 112 could log information collected or generated by the controllers 106 and 108, such as status information related to the operation of the process elements 102 and 104. The servers 110 and 112 could also execute applications that control the operation of the controllers 106 and 108, thereby controlling the operation of the process elements 102 and 104. In addition, the servers 110 and 112 could provide secure access to the controllers 106 and 108. Each of the servers 110 and 112 includes any hardware, software, firmware, or combination thereof for providing access to or control of the controllers 106 and 108. The servers 110 and 112 could, for example, represent personal computers (such as desktop computers) executing a MICROSOFT WINDOWS operating system.

One or more operator stations 124 and 126 are coupled to the servers 110 and 112, and one or more operator stations 128 are coupled to the controllers 106 and 108. The operator stations 124 and 126 represent computing or communication devices providing user access to the servers 110 and 112, which could then provide user access to the controllers 106 and 108 and the process elements 102 and 104. The operator stations 128 represent computing or communication devices providing user access to the controllers 106 and 108 (without using resources of the servers 110 and 112). Each of the operator stations 124, 126 and 128 includes any hardware, software, firmware, or combination thereof for supporting user access and control of system 100. The operator stations 124, 126 and 128 could, for example, represent personal computers having displays and processors executing a MICROSOFT WINDOWS operating system.

In this example, at least one of the operation stations 126 is removed from the servers 110 and 112. The remote station is coupled to the servers 110 and 112 through network 110. The network 110 facilitates communication between various components in the system 100. For example, the network 110 may communication Internet Protocol (IP) packets, frame relay frames, or other suitable information between network addresses. The network 110 may include one or more local area networks (LANs), metropolitan area networks (MANs), wide area networks (WANs), all or a portion of a global network such as the Internet, or other communication system or systems at one or more locations.

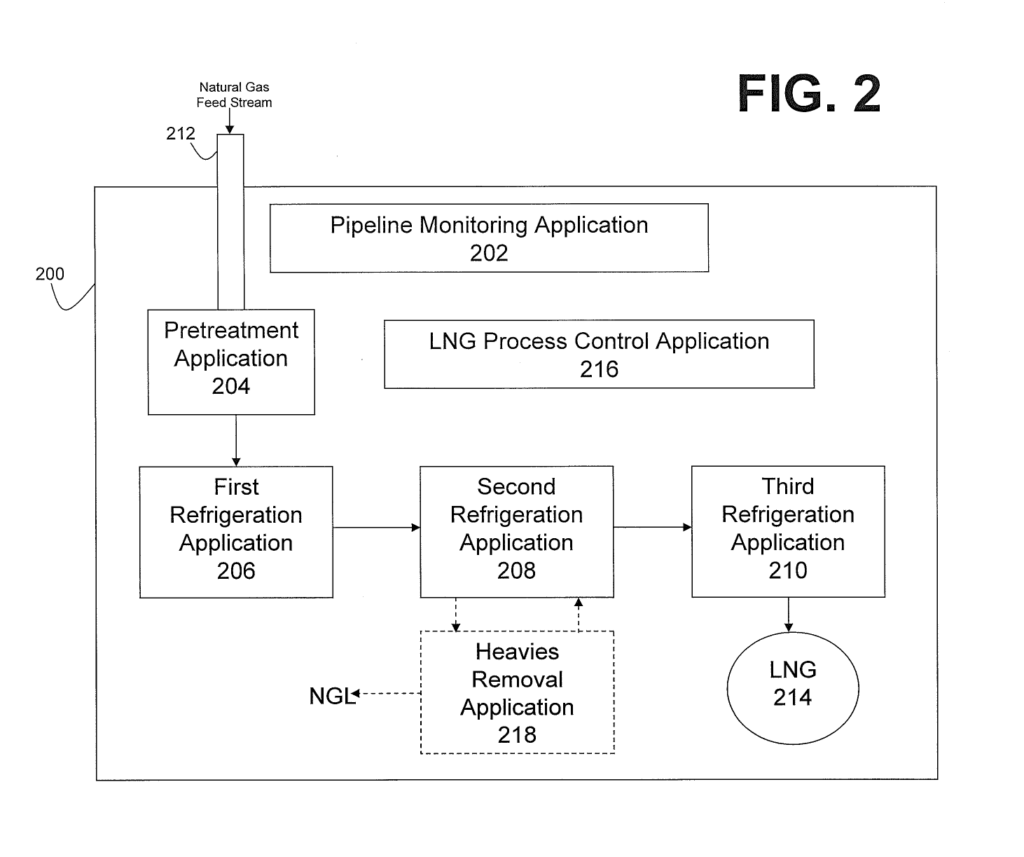

FIG. 2 illustrates the application of a process control system 200 to a liquefied natural gas (LNG) production processing operation according to one embodiment of the present invention. The embodiment of the process control system 200 and the LNG production process shown in FIG. 2 is for illustration only. Other embodiments of the process control system 200 and the LNG production process may be used without departing from the scope of this disclosure.

The process control system 200 of FIG. 2 servers to receive a natural gas feed stream via pipeline 212 and to successively cool the natural gas feed stream to produce LNG products 214, such as liquefied natural gas and related products. The chemical and mechanical processes involved are well known to those of skill in the art. In this example, the process control system 200 includes a LNG process control application 216, which controls the sub-processes involved in the system 200. The sub-processes include those executed by a pipeline monitoring application 202, a pretreatment application 204, a first refrigeration application 206, a second refrigeration application 208, and a third refrigeration application 210. Each of these applications can control multiple controllers and process elements as described above with regard to FIG. 1. Each of the illustrated applications may communicate with the LNG process control application 216 and may communicate with each other. The process control system 200 may be optimized for maximum liquefied natural gas production, quality of liquefied natural gas produced, and other process objectives.

In an embodiment of the present invention, the process control system utilized in an advanced process control system. Specifically, model predictive control (MPC) technology, which predicts the behavior of dependent variables (i.e., outputs) of the modeled dynamic system with respect to changes in the process independent variables (i.e., inputs). Thus, the application of the MPC of the present invention is capable of controlling a plant having long settling times, dead times, complex dynamics or complex interactions. The model predictive controller uses models and current plant measurements to calculate future moves in the independent variables that will result in an operation that honors all independent and dependent variable constraints. The MPC then sends this set of independent variable moves to the corresponding controller setpoints to be implemented in the process. For purposes of simplicity, the advanced process control application described is the model predictive control technology. However, any suitable advanced control technique can be utilized.

The pretreatment application of FIG. 2 provides a means for removing certain undesirable components, such as acid-gases, mercaptan, mercury, and moisture from the natural gas feed stream to the remaining applications. The pretreatment application may be separate steps located either upstream of the cooling cycles or located downstream of one of the earlier liquefaction applications. The following is a non-inclusive listing of some of the available means which are readily known to one skilled in the art. Acid gases and to a lesser extent mercaptan are routinely removed via a chemical reaction process employing an aqueous amine-bearing solution. This treatment step is generally performed upstream of the cooling stages in the initial cycle. A major portion of the water is routinely removed as a liquid via two-phase gas-liquid separation following gas compression and cooling upstream of the initial cooling cycle and also downstream of the first cooling stage in the initial cooling cycle. Mercury is routinely removed via mercury sorbent beds. Residual amounts of water and acid gases are routinely removed via the use of properly selected sorbent beds such as regenerable molecular sieves.

The natural gas feed stream exiting the pretreatment application 204 is then cooled in a plurality of multistage refrigeration cycles or steps (preferably three) by indirect heat exchange with a plurality of different refrigerants (preferably three). Preferably, each of the refrigerants associated with each refrigeration cycle is a single component refrigerant (i.e., not a mixed refrigerant). The overall cooling efficiency for a given cycle improves as the number of stages increases but this increase in efficiency is accompanied by corresponding increases in net capital cost and process complexity.

In FIG. 2, the processed natural gas feed stream exits the pretreatment application 204 and enters the first refrigeration application 206. The feed gas is preferably passed through an effective number of refrigeration stages, nominally two, preferably two to four, more preferably three stages, in a first refrigeration application 206 utilizing a relatively high boiling point refrigerant. Such relatively high boiling point refrigerant is preferably comprised in major portion of propane, propylene, or mixtures thereof, more preferably the refrigerant comprises at least about 75 mole percent propane, even more preferably at least 90 mole percent propane, and most preferably the refrigerant consists essentially of propane.

Thereafter, the processed feed gas flows through an effective number of stages, nominally two, preferably two to four, and more preferably two or three, in a second refrigeration application 208 in heat exchanger with a refrigerant having a lower boiling point. Such lower boiling point refrigerant is preferably comprised in major portion of ethane, ethylene, or mixtures thereof, more preferably the refrigerant comprises at least about 75 mole percent ethylene, even more preferably the refrigerant comprises at least 90 mole percent ethylene, and most preferably the refrigerant consists essentially of ethylene. In the last stage of the second cooling cycle, the liquefaction stream is condensed (i.e., liquefied) in major portion, preferably in its entirety, thereby producing a pressurized LNG-bearing stream. Generally the process pressure at this location is only slightly lower than the pressure of the pretreated gas to the first stage of the first refrigeration application 204.

A portion of the natural gas feed stream could optionally exit the second refrigeration application 208 and may optionally be introduced into heavies removal application 218. The optional heavies removal application 218 could, for example, include a heavies removal column or columns. The heavies removal application 218 produces potentially two products, a “lights stream” and a “heavies stream.” The “lights stream” is devoid of residual amounts of heavy components, i.e., benzene and other aromatic compounds, and is subsequently returned to the second refrigeration application 208. The “heavies stream” produces an independent product known as natural gas liquids (NGL).

After being processed in the second refrigeration application 208, the pressurized LNG-bearing stream is then further cooled in a third refrigeration application 210 referred to as the open methane cycle via contact in a methane economizer with flash gases generated in this third refrigeration application 210 in a manner to be described later and via sequential expansion of the pressurized LNG-bearing stream to near atmospheric pressure. The flash gasses used as a refrigerant in the third refrigeration application 210 are preferably comprised in major portion of methane, more preferably the flash gas refrigerant comprises at least 75 mole percent methane, still more preferably at least 90 mole percent methane, and most preferably the refrigerant consists essentially of methane. During expansion of the pressurized LNG-bearing stream to near atmospheric pressure, the pressurized LNG-bearing stream is preferably cooled via at least three sequential expansions where each expansion employs an expansion device as a pressure reduction means. The expansion is followed by a separation of the gas-liquid product with a separator.

In this document, the term “application” refers to one or more computer programs, sets of instructions, procedures, functions, objects, classes, instances, or related data adapted for implementation in a suitable computer language. An application may be configured to run and control a particular section of an operating process. An application could also be configured to maximize profit, quality, production, or other objectives. As a particular example, each application could be configured with or operate using manipulated variables (MV), controlled variables (CV), disturbance variables (DV), and a control horizon over which the application operates to ensure that the variables are brought inside limits specified by an operator. A controlled variable represents a variable that a controller attempts to maintain within a specified operating range or otherwise control. A manipulated variable represents a variable manipulated by the controller to control a controlled variable. A disturbance variable represents a variable that affects a controlled variable but that cannot be controlled by the controller.

The preferred embodiment of the present invention has been disclosed and illustrated. However, the invention is intended to be as broad as defined in the claims below. Those skilled in the art may be able to study the preferred embodiments and identify other ways to practice the invention that are not exactly as described in the present invention. It is the intent of the inventors that variations and equivalents of the invention are within the scope of the claims below and the description, abstract and drawings not to be used to limit the scope of the invention.

1. A method comprising:
a) controlling a liquefied natural gas (LNG) production process for producing liquefied natural gas using an advanced process control system, wherein the advanced process control system employs a model predictive controller, wherein the model predictive controller includes variables such as controlled, manipulated and disturbance, wherein the model predictive controller includes a control route for determining moves of the manipulated variables based on controlled variable(s) and one or more of the disturbance variables; and
b) controlling the advanced process control system so as to optimize at least one process objective using the advanced process control system.

2. The method according to claim 1, wherein the liquefied natural gas (LNG) production process includes treating the natural gas feed stream in a pretreatment application, successively cooling the natural gas feed stream in a first refrigeration application employing a first refrigerant, a second refrigeration application employing a second refrigerant, and a third refrigeration application employing a third refrigerant.

3. The method according to claim 2, wherein the first refrigeration application includes a plurality of refrigeration stages.

4. The method according to claim 3, wherein the first refrigeration application includes two to four refrigeration stages, preferably three.

5. The method according to claim 2, wherein the first refrigerant comprises predominately propane, propylene, or mixtures thereof.

6. The method according to claim 2, wherein the second refrigeration application includes a plurality of refrigeration stages.

7. The method according to claim 6, wherein the second refrigeration application includes two to four refrigeration stages, preferably two.

8. The method according to claim 2, wherein the second refrigerant comprises predominately ethane, ethylene, or mixtures thereof.

9. The method according to claim 2, wherein the third refrigerant comprises predominately methane.

10. The method according to claim 1, wherein the process objective is to maximize recovery of liquefied natural gas while optimizing feed gas provided to the LNG production process.

11. The method according to claim 1, wherein the process objective is to provide the liquefied natural gas on a shipment by shipment basis.

12. The method according to claim 1, wherein the process control system is configured to control a plurality of controllers, each controller configured to control at least one sub-process.

13. A method comprising:
a) controlling a liquefied natural gas (LNG) production process for producing liquefied natural gas using an advanced process control system; and
b) controlling the advanced process control system so as to optimize at least one process objective using the advanced process control system.

14. The method according to claim 13, wherein the advanced process control system employs a model predictive controller.

15. The method according to claim 14, wherein the model predictive controller includes variables such as controlled, manipulated and disturbance.

16. The method according to claim 15, wherein the model predictive controller includes a control route for determining moves of the manipulated variables based on controlled variable(s) and one or more of the disturbance variables.

17. The method according to claim 13, wherein the liquefied natural gas (LNG) production process includes treating the natural gas feed stream in a pretreatment application, successively cooling the natural gas feed stream in a first refrigeration application employing a first refrigerant, a second refrigeration application employing a second refrigerant, and a third refrigeration application employing a third refrigerant.

18. The method according to claim 17, wherein the first refrigeration application includes a plurality of refrigeration stages.

19. The method according to claim 18, wherein the first refrigeration application includes two to four refrigeration stages, preferably three.

20. The method according to claim 17, wherein the first refrigerant comprises predominately propane, propylene, or mixtures thereof.

21. The method according to claim 17, wherein the second refrigeration application includes a plurality of refrigeration stages.

22. The method according to claim 21, wherein the second refrigeration application includes two to four refrigeration stages, preferably two.

23. The method according to claim 17, wherein the second refrigerant comprises predominately ethane, ethylene, or mixtures thereof.

24. The method according to claim 17, wherein the third refrigerant comprises predominately methane.

25. The method according to claim 13, wherein the process objective is to maximize recovery of liquefied natural gas while optimizing feed gas provided to the LNG production process.

26. The method according to claim 13, wherein the process objective is to provide the liquefied natural gas on a shipment by shipment basis.

27. The method according to claim 13, wherein the process control system is configured to control a plurality of controllers, each controller configured to control at least one sub-process.

28. A computer program embodied on a computer readable medium, the computer program comprising computer readable code for:
a) controlling a process control system that controls a process comprising a liquefied natural gas production process; and
b) optimizing at least one process objective using the first process control system.
